(19) United States
(12) Patent Application Publication
(10) Pub. No.: US 2025/0390574 A1
(43) Pub. Date: Dec. 25, 2025

(54) ENHANCED DATA PRUNING STRATEGY FOR MALWARE DETECTION MODELS

(71) Applicant: CrowdStrike, Inc., Sunnyvale, CA (US)

(72) Inventors: Hector Flores Rodriguez, Humble, TX (US); Laura Angelescu, Los Angeles, CA (US); Nick Yarbrough, Galivants Ferry, SC (US); Calin-Bogdan Miron, Nottingham (GB)

(21) Appl. No.: 18/753,821

(22) Filed: Jun. 25, 2024

(51) Int. Cl. G06F 21/56

(52) U.S. Cl. CPC G06F 21/566; G06F 2221/034

(57) ABSTRACT

Methods and systems for implementing enhanced data pruning strategy for malware detection models are described herein. According to an implementation, a computer device may distribute data associated with detected events into a plurality of storages. The computer device may sequentially perform one or more sampling operations to construct a dataset for malware detection model training. The computer device may first select a subset of the plurality of storages, each having a size equal to or less than a threshold, to be used for model training without pruning. The computer device may then select top-n most recent samples and top-n least confident samples from each of rest storages. Further, the computer device may perform Monte Carlo sampling enhanced with a power transformation on the rest storages to generate additional samples. The compute device may then generate the training dataset for the malware detection model training based on the sequentially sampling results.

### BACKGROUND

In the rapid evolving landscape of cybersecurity, malware detection models must process an ever-growing influx of data. The sheer volume of data can be overwhelming and the traditional data handling techniques often fall short. Further, existing models for classifying malicious portable executable (PE) files also face a significant challenge of learning from an immense dataset that not only strains computational resources but also risks overfitting due to data redundancy.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical components or features.

FIG. 1 illustrates an example scenario, in which, an enhanced data pruning strategy for malware detection is implemented, according to an example of the present disclosure.

FIG. 2 illustrates an example scenario, in which, the sequential sampling strategy is implemented on the training data for malware detection model, according to an example of the present disclosure.

FIG. 3 illustrates an example scenario, in which, the sequential sampling strategy is implemented on the training data for malware detection model, according to another example of the present disclosure.

FIG. 4 illustrate an example scenario, in which, the sequential sampling strategy is implemented on the training data for malware detection model, according to yet another example of the present disclosure.

FIG. 5 illustrates an example scenario, in which, the sequential sampling strategy is implemented on the training data for malware detection model, according to yet another example of the present disclosure.

FIG. 6 illustrates an example scenario, in which, the sequential sampling strategy is implemented on the training data for malware detection model, according to yet another example of the present disclosure.

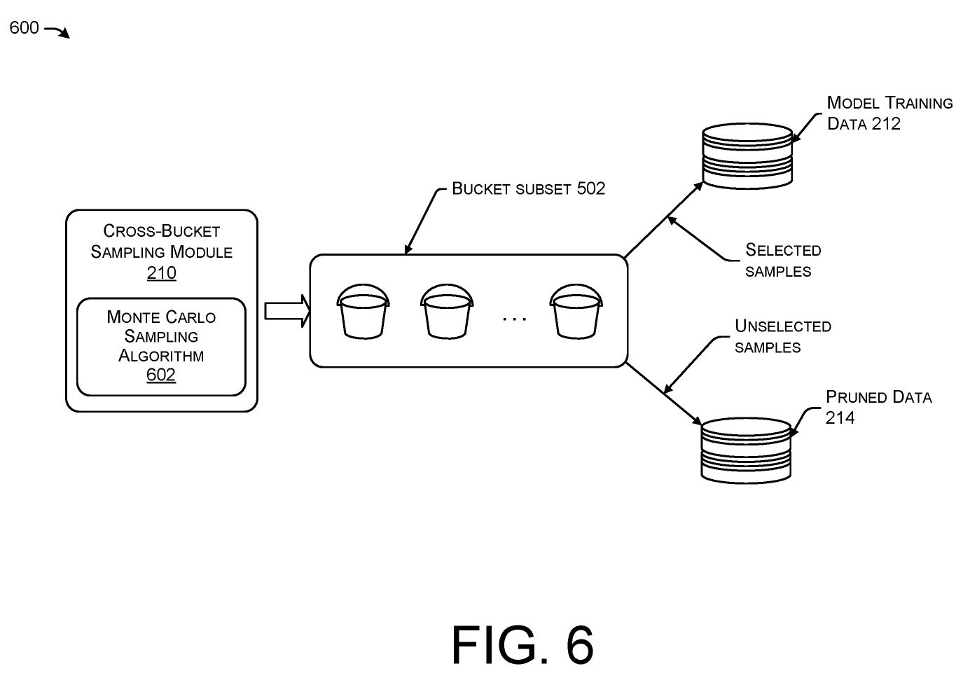

FIG. 7 illustrates an example process for enhanced data pruning strategy for malware detection model, according to an example of the present disclosure.

FIG. 8 illustrates an example computer device that implements techniques for enhanced data pruning for malware detection model, according to an example of the present disclosure.

### DETAILED DESCRIPTION

Techniques for implementing an enhanced data pruning strategy for malware detection are disclosed herein.

According to an aspect of the present disclosure, a method for pruning data for malware detection model training may be implemented on a computer device configured to process data associated with detected malware attacks in a computer network and/or cloud environment and prepare training data in order to continuously train any malware detection models. The computer device may receive data associated with events detected in a computer network. The data may represent a sample generated based on the event and include information associated with the event and a detection result outputted by a malware detection model. The detection result may indicate whether the event is related to a malicious activity, a type of the malicious activity, and a confidence level of the detection result (i.e., how likely the event is related to a malicious activity). The computer device may further distribute the data into a plurality of storages (e.g., data storages, buckets, etc.). Once the data is bucketed, the computer device may perform a threshold sampling and determine a subset storages of the plurality of storages, where a number of data samples in each of the subset storage is equal to or less than a threshold. In some examples, the threshold may be determined using an empirical cumulative distribution function (ECDF). The computer device may save the data samples in the subset storages as a first set of data samples for malware detection model training. For the rest storages from the plurality of storages (i.e., the number of data samples in each rest storage being greater than the threshold), the computer device may further sequentially perform an individual sampling on each storage to obtain a second set of data samples and a cross bucket sampling across the one or more storages to obtain a third set of data samples. Based on the first set of data samples, the second set of data samples, and the third set of data samples, the computer device may generate a training dataset for the malware detection model training.

In implementations, the computer device may group similar data samples to a same storage using fuzzy/similarity hashing techniques such as DeepHash, a locality sensitive hashing (LSH) algorithm.

In implementations, the individual sampling may include one or more sequentially sampling operations. In some examples, the computer device may select a first number of most recent data samples from each of the rest storages. For instance, the computer device may select top-n most recent data samples from each of the rest storages. The top-n most recent data samples may be removed from the rest storages and saved for the malware detection model training.

In some examples, the computer device may select a second number of least confident data samples from each of the rest storages after the top-n most recent data sampling. For instance, the computer device may select top-n least confident data samples from each of the rest storages. The top-n least confident data samples may be further removed from the rest storages and saved for the malware detection model training. The computer device may combine the top-n most recent data samples and the top-n least confident data samples as the second set of data samples.

In implementations, the computer device may apply a power transformation based on individual sizes of the storages for probabilistic weighting samples across all the storages. In some examples, the computer device may implement a Monte Carlo sampling strategy enhanced with the power transformation to select the third set of data samples.

The present disclosure implements a sequential sampling strategy on the bucketed data to generate a data set for malware detection model training. The sequential sampling strategy may include a threshold sampling, a top-n most recent data sampling, a top-n least confident data sampling, a Monte Carlo sampling with enhanced power transformation, etc. By pruning data using the sequential sampling strategy, the model training data may be constructed to include the common pattern data samples yet with a focus on rare and/or more recent data samples and challenging data samples (e.g., data sample having low confidence level). Redundant data that leads to model overfitting can be removed. The malware detection model trained on a more concise and representative dataset can generalize better to new and unseen malware samples, which is crucial for robust malware defense.

Example implementations are provided below with reference to the following figures.

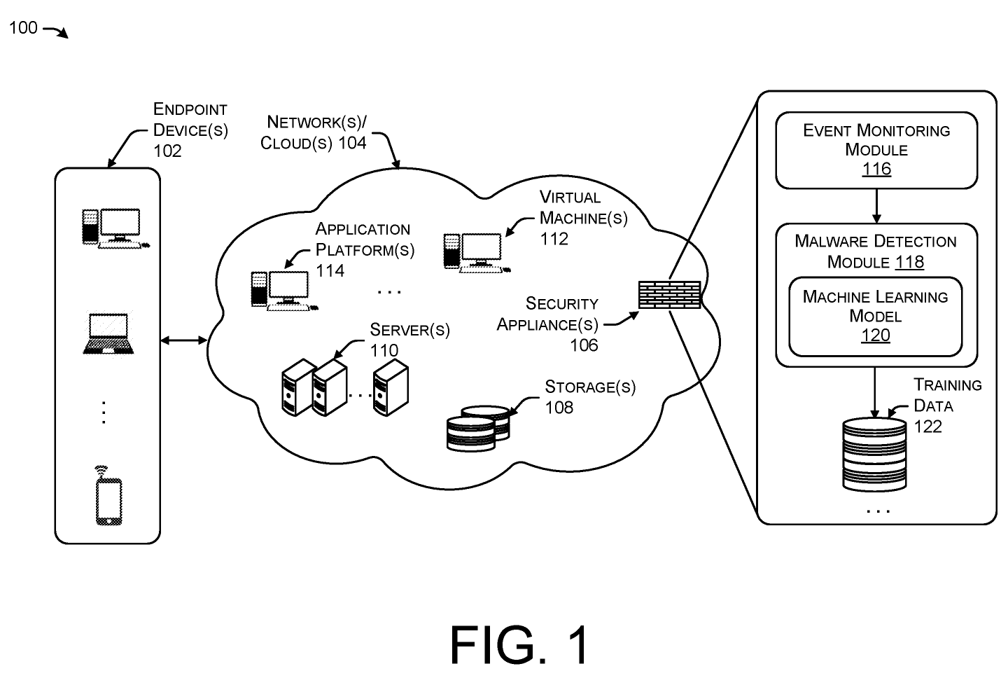

FIG. 1 illustrates an example scenario, in which, an enhanced data pruning strategy for malware detection is implemented, according to an example of the present disclosure.

As illustrated in FIG. 1, the network scenario 100, in which methods and systems for enhanced data pruning is implemented may include one or more endpoint device(s) 102 that can access, through a network, a variety of resources located in network(s)/cloud(s) 104. The network scenario 100 may further include one or more security appliance(s) 106 configured to provide an intrusion detection or prevention system (IDS/IPS), denial-of-service (DoS) attack protection, session monitoring, and other security services to the devices in the network(s)/cloud(s) 104.

In various examples, the endpoint device(s) 102 may be any device that can connect to the network(s)/cloud(s) 104, either wirelessly or in direct cable connection. For example, the endpoint device(s) 102 may include but are not limited to a personal digital assistant (PDA), a media player, a tablet computer, a gaming device, a smart watch, a hotspot, a personal computer (PC) such as a laptop, desktop, or workstation, or any other type of computing or communication device. In some examples, the endpoint device(s) 102 may include the computer devices implemented on the vehicle including but are not limited to, an autonomous vehicle, a self-driving vehicle, or a traditional vehicle capable of connecting to internet. In yet other examples, the endpoint device(s) 102 may be a wearable device, wearable materials, virtual reality (VR) devices, such as a smart watch, smart glasses, clothes made of smart fabric, etc.

In various examples, the network(s)/cloud(s) 104 can be a public cloud, a private cloud, or a hybrid cloud and may host a variety of resources such as one or more storage(s) 108, one or more server(s) 110, one or more virtual machine(s) 112, one or more application platform(s) 114, etc. The server(s) 110 may include the pooled and centralized server resources related to application content, storage, and/or processing power. The application platform(s) 114 may include one or more cloud environments for designing, building, deploying and managing custom business applications. The virtual desktop(s) 112 may image the operating systems and application of the physical device, e.g., the endpoint device(s) 102, and allow the users to access their desktops and applications from anywhere on any kind of endpoint devices. The storage(s) 108 may include one or more of file storage, block storage or object storage.

It should be understood that the one or more storage(s) 108, one or more server(s) 110, one or more virtual machine(s) 112, one or more application platform(s) 114 illustrate multiple functions, available services, and available resources provided by the network(s)/cloud(s) 104. Although shown as individual network participants in FIG. 1, the storage(s) 108, the server(s) 110, the virtual machine(s) 112, and the application platform(s) 114, can be integrated and deployed on one or more computer devices and/or servers in the network(s)/cloud(s) 104.

In implementations, the security appliance(s) 106 can be any types of firewalls. An example of the firewalls may be a packet filtering firewall that operates inline at junction points of the network devices such as routers and switches. The packet filtering firewall can compare each packet received to a set of established criteria, such as the allowed IP addresses, packet type, port number and other aspects of the packet protocol headers. Packets that are flagged as suspicious are dropped and not forwarded. Another example of the firewalls may be a circuit-level gateway that monitors TCP handshakes and other network protocol session initiation messages across the network to determine whether the session being initiated is legitimate. Yet another example of the firewalls may be an application-level gateway (also referred to as a proxy firewall) that filters packets not only according to the service as specified by the destination port but also according to other characteristics, such as the HTTP request string. Yet another example of the firewalls may be a stateful inspection firewall that monitors the entire session for the state of the connection, while also checks IP addresses and payloads for more thorough security. A next-generation firewall, as another example of the firewall, can combine packet inspection with stateful inspection and can also include some variety of deep packet inspection (DPI), as well as other network security systems, such as IDS/IPS, malware filtering and antivirus.

In various examples, the security appliance(s) 106 (i.e., the one or more firewalls) can be normally deployed as a hardware-based appliance, a software-based appliance, or a cloud-based service. The hardware-based appliance may also be referred to as network-based appliance or network-based firewall. The hardware-based appliance, for example, the security appliance(s) 106, can act as a secure gateway between the network(s)/cloud(s) 104 and the endpoint device(s) 102 and protect the devices/storages inside the perimeter of the networks/cloud(s) 104 from getting attacked by the malicious actors. Additionally or alternatively, the hardware-based appliance can be implemented on a cloud device to intercept the attacks to the cloud assets. In some other examples, the security appliance(s) 106 can be a cloud-based service, in which, the security service is provided through managed security service providers (MSSPs). The cloud-based service can be delivered to various network participants on demand and configured to track both internal network activity and third-party on-demand environment. In some examples, the security appliance(s) 106 can be software-based appliance implemented on the individual endpoint device(s) 102. The software-based appliance may also be referred to as host-based appliance or host-based firewall. The software-based appliance may include the security agent, the anti-virus software, the firewall software, etc., that are installed on the endpoint device(s) 102.

In FIG. 1, the security appliance(s) 106 is shown as an individual device and/or an individual cloud participant. However, it should be understood that the network scenario 100 may include multiple security appliance(s) respectively implemented on the endpoint device(s) 102, or the network(s)/cloud(s) 104. As discussed herein, the security appliance(s) 106 can be a hardware-based firewall, a software-based firewall, a cloud-based firewall, or any combination thereof. The security appliance(s) 106 can be deployed on a server (i.e., a router or a switch) or individual endpoint device(s) 102. The security appliance(s) 106 can also be deployed as a cloud firewall service delivered by the MSSPs.

In some examples, the security appliance(s) 106 may include an event monitoring module 116 and a malware detection module 118. The event monitoring module 116 may constantly monitor real-time user activities associated with one or more resources located in network(s)/cloud(s) 104. By way of example and without limitation, the real-time user activities may include attempting to log in to a secured website through the endpoint device(s) 102 and/or the application platform(s) 114, clicking a phishing link on a website or in an email from the endpoint device(s) 102 and/or the virtual machine(s) 112, attempting to access files stored in the database(s)/storage(s) 108, attempting to log in to the server(s) 110 as an administrator account, attempting to configure and/or re-configure the settings of various assets on the network(s)/cloud(s) 104, etc. The information associated with the real-time user activities may be cached as event log data. The event log data may generally include a timestamp for each logged event, a user account associated with the event, an IP address of a computer device that generates the event, an HTTP address of a link being clicked by the user, a command line entered by the user, etc. The context behind the event log data may be used to interpret the potential purpose of the user behavior and to determine whether a user behavior is a malicious or not. The event log data may be further fed into the malware detection module 118. In some examples, the event log data may be pre-processed before it is provided to the malware detection module 118 as the quality of data also affects the usefulness of the information derived from the data.

The malware detection module 118 may include a machine learning (ML) model 120 trained to produce a likelihood of an anomaly. In some examples, the machine learning (ML) model 120 may also produce context associated with the anomaly such as the type of the detected anomaly. In some examples, the malware detection module 118 may use multiple types of machine learning models and/or algorithms to perform anomaly detection. The training of the multiply types of machine learning models may be performed by a separate computer device such as the server(s) 110 in the network(s)/cloud(s) 104. When the performance of the machine learning model 120 satisfies a criteria, the server(s) 110 may deploy the machine learning model 120 in the security appliance(s) 106.

In some examples, for a detected event, the malware detection module 118 may execute the machine learning model 120 to output a decision result with a confidence level (e.g., whether the event is malicious with 60% confidence level). The decision result may be associated with the event log data and form a sample of the training data 122. In some examples, the training data 122 may be stored in a distributed data storage platform and/or a cloud storage platform containing a plurality of buckets. Similar samples may be grouped together and saved in a same bucket. As discussed herein, the event data associated with the detected activities in the network(s)/cloud(s) 104 are now growing rapidly, causing an overwhelming volume of the training data. This poses challenges in model scalability, data overfitting and generalization, and training efficiency. To address these challenges, a naïve random sampling may be performed on the training data across all the buckets. However, the naïve random sampling has no specific target on the training dataset. The present disclosure implements a sequential sampling strategy to prune the training data 122 to obtain a more focused or targeted training dataset for the purpose of efficient training of the machine learning model 120 of the malware detection module 118. In some examples, the sequential sampling strategy may involve a threshold sampling to retain the entire data samples in the small-sized buckets. The sequential sampling strategy may also include a top-n most recent sampling to recognize the significance of temporal patterns in malware. The sequential sampling strategy may further involve a top-n least confident sampling to prioritize the samples where the output confidence levels are the lowest, addressing the areas where the performance of the machine learning model 120 could be improved. In implementations, the sequential sampling strategy may further involve Monte Carlo sampling enhanced with a power transformation across all the buckets to ensure diverse coverage.

Comparing to the naïve random sampling, the sequential sampling strategy utilizes a reduced size of the training dataset yet still effectively retains critical information necessary for the machine learning model’s accuracy and generalizability. In addition, by focusing on the areas of low confidence and new emerging patterns in malware events, the present disclosure can significantly improve the performance of the machine learning model 120 of the malware detection module 118.

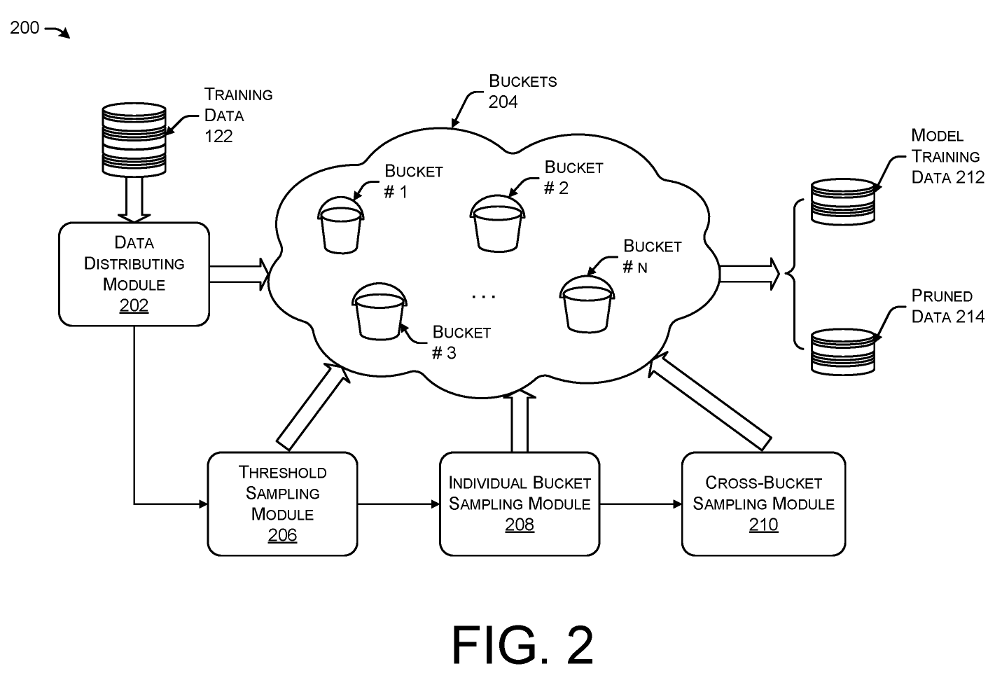

FIG. 2 illustrates an example scenario, in which, the sequential sampling strategy is implemented on the training data for malware detection model, according to an example of the present disclosure.

As shown in the example scenario 200, training data 122 may be segmented to a plurality of buckets 204 by a data distributing module 208. In general, similar data samples may be grouped together and saved in a same bucket. As such, the sizes of the plurality of buckets (e.g., bucket #1, bucket #2, bucket #3, …, bucket #n) may vary. The data distributing module 208 may utilize a fuzzy/similarity hash algorithm to segment data samples for bucketing. In some examples, the data distributing module 208 may utilize a locality sensitive hashing (LSH) algorithm such as DeepHash to group similar data samples. The data distributing module 208 may use the LSH algorithm to compute hash value collisions on the training data 122 and/or between a new data sample and the existing training data. As discussed herein, the LSH algorithm is designed so that the hash value collisions are more likely for two input values that are close together than for the two input values that are far apart. Based on the computed hash value collisions, the data distributing module 208 may distribute the data samples into the plurality of buckets 204. In some examples, buckets containing a large size of data samples may represent more common patterns while buckets containing a small size of data samples may represent rare and/or new patterns.

In some examples, the sequential sampling strategy may be implemented by one or more computer-executable modules including but are not limited to a data distributing module 202, a threshold sampling module 206, an individual bucket sampling module 208, a cross-bucket sampling module 210, etc. Sampling operations on the bucketed training data 122 may be individually and sequentially performed by the one or more computer-executable modules.

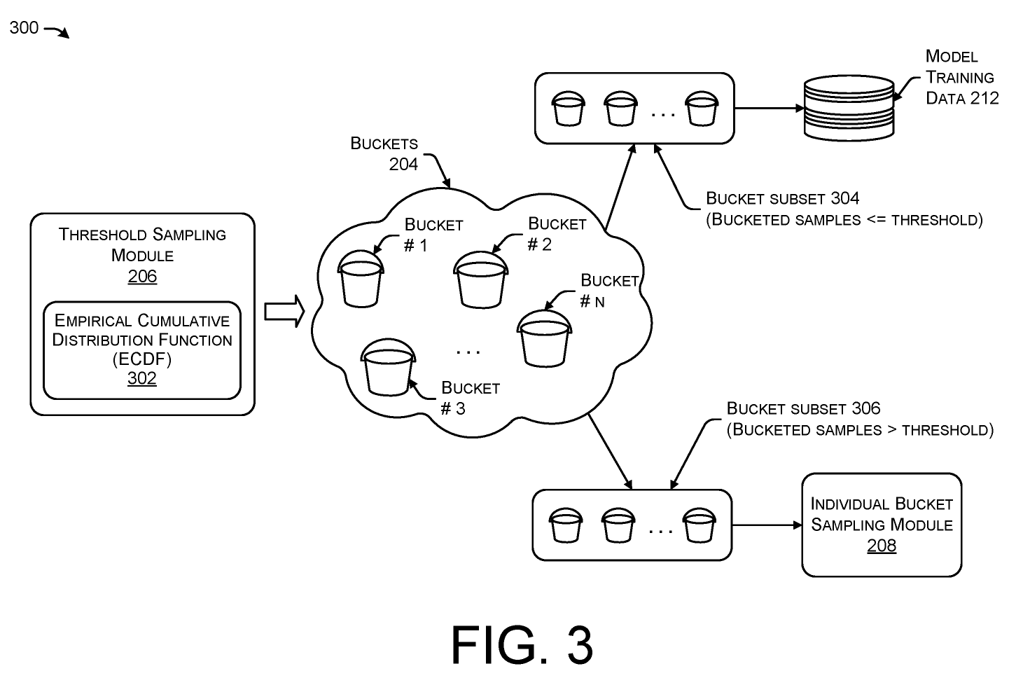

In some examples, once the training data 122 is distributed to the plurality of buckets 204, the threshold sampling module 206 may set a threshold to determine which buckets of data to prune. As illustrated in scenario 300 of FIG. 3, the threshold sampling module 206 may execute an empirical cumulative distribution function (ECDF) 302 to determine the threshold for pruning the buckets of data yet rare but potentially critical patterns can be retained. Based on a visual inspection of the ECDF, 99.75% of the plurality of buckets 204 contain 271 or fewer samples. In the context of DeepHash or locality-sensitive hashing in general, these smaller sized buckets are potentially significant as they may represent rare and more unique patterns in the training data 122. In some examples, the ECDF 302 may exhibit an inflection around a bucket size of 10, which corresponds to approximately 90% of the buckets. As a more conservative approach, the threshold sampling module 206 may set the threshold that corresponds to approximately 99.75% of the plurality of buckets 204. As such, retaining these smaller buckets may preserve the diversity and uniqueness of the training data 122. The remaining 0.25% of the buckets, each with more than 270 samples, signifies more common patterns, which could be pruned for model training. The threshold sampling module 206 may then yield a bucket subset 304 that forms a first set of data samples for model training (e.g., buckets of data samples where a number of samples in each bucket being no greater than the threshold). That is, the first set of data samples for model training includes the small-sized buckets with no data pruning. In some examples, the first set of data samples may then be stored in a pool to construct model training data 212. The threshold sampling module 206 may also yield a bucket subset 306, i.e., the large-sized buckets where a number of samples in each bucket is greater than the threshold. The large-sized buckets, e.g., the bucket subset 306, may be sent to the individual bucket sampling module 208 and the cross-bucket sampling module 210 for further pruning.

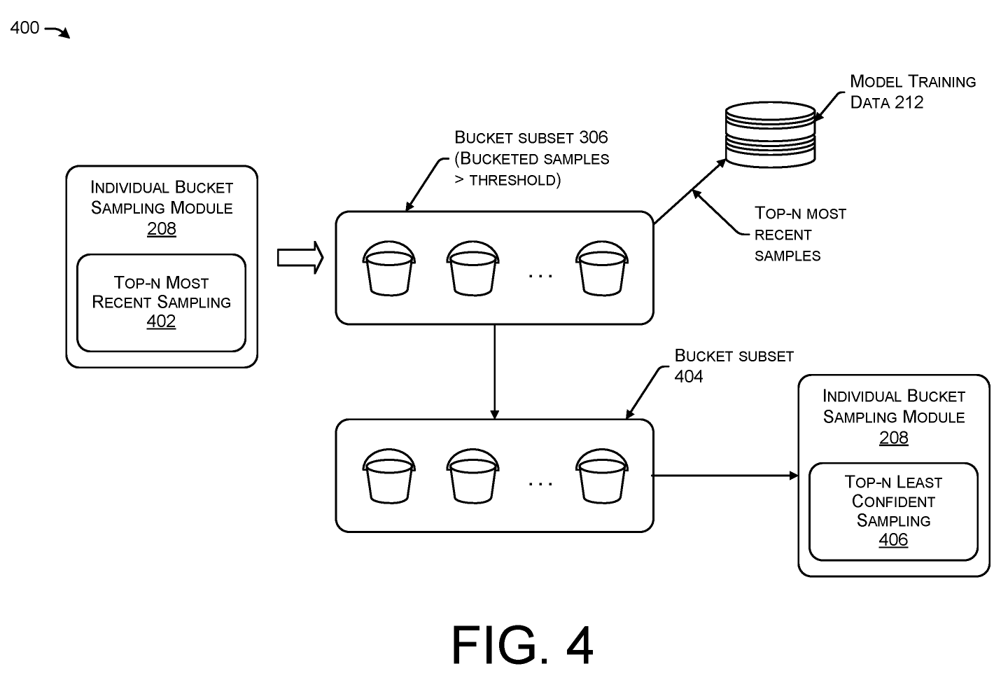

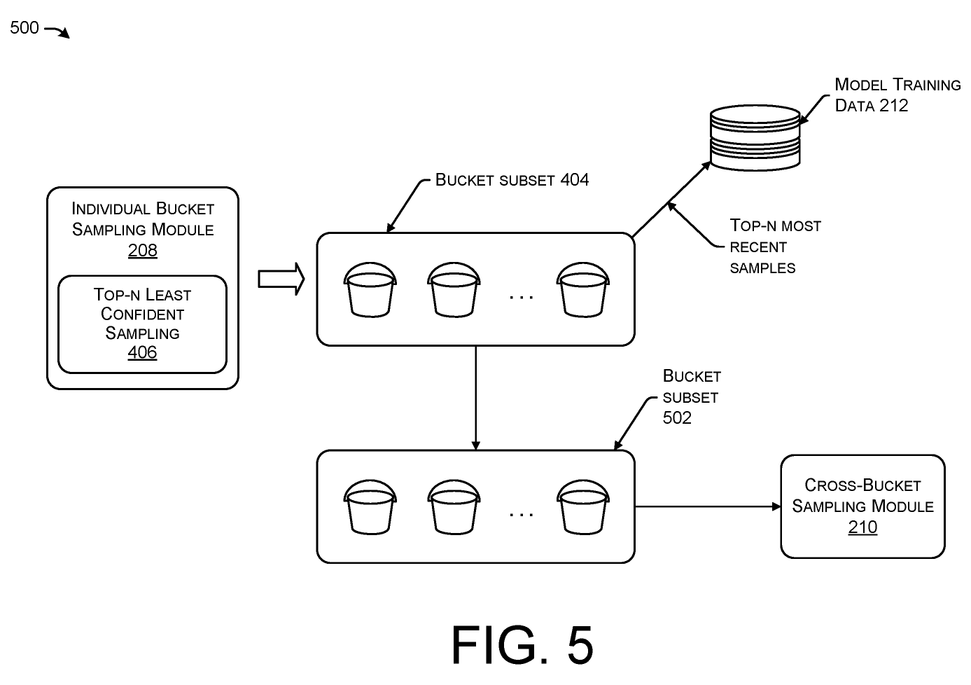

The individual bucket sampling module 208 may further perform one or more samplings on each of the bucket subset 306. For instance, as illustrated in scenario 400 of FIG. 4, the individual bucket sampling module 208 may perform a top-n most recent sampling 402 and select top-n most recent samples from each of the bucket subset 306. As discussed herein, the most recent samples may be related to some new malicious attacks and exhibit the new patterns that were never used to train a malware detection model (e.g., the machine learning model 120 of the malware detection module 118 shown in FIG. 1). As such, targeting on the most recent samples may ensure the most recent patterns are included for malware detection model training. The individual bucket sampling module 208 may determine the top-n most recent samples based on a timestamp associated with each data sample. The selected top-n most recent samples may be stored in the pool to construct the model training data 212. The individual bucket sampling module 208 may remove the selected top-n most recent samples from the bucket subset 306 and generate a bucket subset 404 for further sampling process. The individual bucket sampling module 208 may further perform a top-n least confident sampling 406 and select top-n least confident samples from each of the bucket subset 404. As discussed herein, when a new event is detected by a security agent in the network (e.g., the security appliance(s) 106 in FIG. 2), the machine learning model 120 of the malware detection module 118 may determine whether the new event is associated with a malicious attack and how likely the new event is a malicious attack. For instance, a detected portable executable (PE) file, after passing through the malware detection module 118, may be determined to have a low confidence level of being a malicious file. Such PE file, if falling within the top-n least confidence samples, may then be selected to further train the malware detection model. As illustrated in FIG. 5, the selected top-n least confident samples may be stored in the pool to construct the model training data 212. The individual bucket sampling module 208 may remove the selected top-n least confident samples from the bucket subset 404 and generate a bucket subset 404 for further sampling process, e.g., cross-bucket sampling 210. In some examples, the top-n most recent samples and the top-n least confident samples may form the second set of data samples used for model training.

In some examples, a cross-bucket sampling module 210 may further perform a Monte Carlo sampling algorithm 602 enhanced with a power transformation on the bucket subset 502. The Monte Carlo sampling enhanced with a power transformation may ensure that buckets of all sizes contribute to the model training data, with larger buckets contributing more samples but at a diminishing rate. As illustrated in FIG. 5, The cross-bucket sampling module 210 may then send the selected samples (e.g., the third set of data samples) to a database that stores the model training data 212.

The cross-bucket sampling module 210 may archive the unselected data samples to a database that stores the pruned data 214. The pruned data 214 may also include information such as when the data sample is pruned, the reason for pruning, the sampling strategy being used for pruning, performance metrics related to the pruning, etc. In implementations, the pruned data 214 may be periodically revisited to determine whether those data samples are now relevant to the malware detection. If some pruned data samples appear to be more relevant due to the shifts in trends, those data samples may be retrieved and placed in the database for model training. In some examples, the computer device may periodically retrain the malware detection model (e.g., the machine learning model 120) based on the entire bucketed data set without pruning.

Once the threshold sampling operation, the individual sampling operation (e.g., top-n most recent sampling and top-n least confident sampling), and the cross bucket sampling operation are sequentially performed, the model training data 212 may be constructed based on the first set of data samples, the second set of data samples, and the third set of data samples in the pool. Instead of randomly sampling the buckets of data, the present disclosure targets on those rare or less-frequently observed patterns and the new patterns that were not included in the model training yet balancing the more commonly seen patterns. In addition, the present disclosure performs the sequential sampling operations for real-time detected event data to ensure the model training data 212 is constantly updated.

In implementations, the data distributing module 202, the threshold sampling module 206, the individual bucket sampling module 208, and the cross-bucket sampling module 210 may be implemented by one or more computer devices, for example, the security appliance(s) 106 and/or the server(s) 110 in the network(s)/cloud(s) 104, as shown in FIG. 1. The model training data 212 and the pruned data 214 may be stored in one or more storages accessible to the one or more computer devices. In some examples, the model training data 212 and the pruned data 214 may be stored in the storage(s) 108 in the network(s)/cloud(s) 104, as shown in FIG. 1. A computer device, e.g., the server(s) 110, may periodically train the machine learning model 120 using the constantly updated model training data 212. In some examples, the computer device may perform data reassessment by periodically revisiting the pruned data 214 as the pruned data may be relevant again due to pattern shifts in trends. Additionally, the computer device may perform model reassessment by periodically retraining the machine learning model 120 on the entire training data 122.

In some examples, the computer device may construct a validation dataset from the training data 122 to validate the trained machine learning model 120. In some examples, the validation dataset may include a subset of the pruned data 214 such as the borderline samples. In some other examples, the computer device may create a separate validation dataset on the pruned data 214. Yet in some other examples, the computer device may periodically include the pruned data 214 in the validation dataset as an audit process.

It should be understood that the data distributing module 202, the threshold sampling module 206, the individual bucket sampling module 208, and the cross-bucket sampling module 210 of FIG. 2 are for the purpose of illustration. The present disclosure is not intended to be limiting. The sequential samplings may include one or more additional sampling schemes to prune the original training data 122. For instance, the sequential samplings may also include a sampling module that targets at the data samples associated with a particular computer server, a particular IP address, a particular file type, etc. Further, the order of the sequential samplings may vary. For instance, the top-n least confident sampling 502 may be performed prior to the top-n most recent sampling 402. The cross-bucket sampling module 210 may perform the random sampling across all buckets prior to one or more of the threshold sampling (e.g., by ECDF 302), the top-n most recent sampling 402, or the top-n least confident sampling 502. Additionally and/or alternatively, the sampling threshold, functions, and/or algorithms are not limited to those described herein. The threshold sampling module 206 may use another cumulative distribution function to set a threshold other than 99.75% to include more or less buckets of data. The individual bucket sampling module 208 may select top-5 most recent samples and top-5 most least confident samples from each bucket. However, the individual bucket sampling module 208 may select any number of the top most recent samples and the most least confident samples from each bucket. The cross-bucket sampling module 210 may also adopt a different algorithm to perform sampling across all the buckets based on the sizes of the buckets.

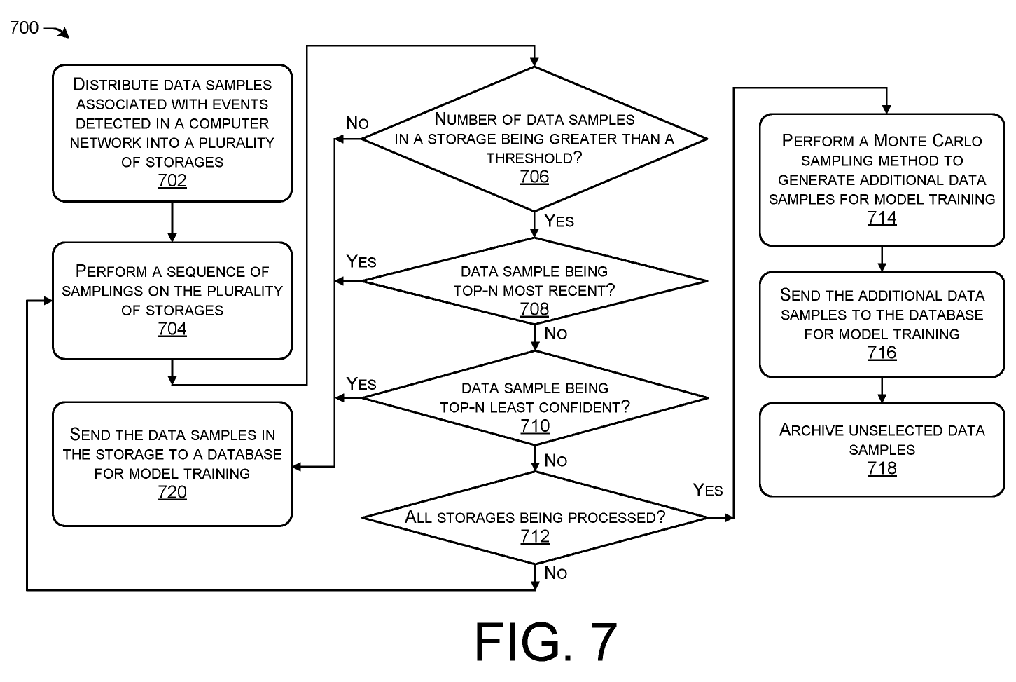

FIG. 7 illustrates an example process for enhanced data pruning strategy for malware detection model, according to an example of the present disclosure. The operations following the example process 700 may be performed by a computer device that implements the data distributing module 202, the threshold sampling module 206, the individual bucket sampling module 208, and the cross-bucket sampling module 210, as shown in FIG. 2. The computer device may include the server(s) 110 and/or the security appliance(s) 106, as shown in FIG. 1.

At operation 702, the process may include distributing data samples associated with events detected in a computer network into a plurality of storages. In some examples, the events may be detected by a computer device acting as a firewall or a security agent of the computer network, e.g., the security appliance(s) 106 shown in FIG. 1. The security appliance(s) 106 may execute a malware detection model (e.g., the machine learning model 120 of FIG. 1) to determine how likely a detected event is related to malicious attacks. In some examples, the event may be detected when a computer-readable file is automatically executed on a computer device, causing unusual or suspicious activities in the network (e.g., multiple attempts to access one or more network entities). The data associated with the event may include information about the computer-readable file, an IP address from which the file is sent, a destination IP address of an entity in the network, operations performed when the computer-readable file is executed, a timestamp when the event is detected, a detection result outputted by the malware detection model (e.g., whether the event is related to a malicious activity, a confidence score as to whether the event is malicious), etc.

As discussed herein, information related to the detected events and the detection results outputted by the malware detection model may be combined together to form a data sample. The security appliance(s) 106 may continuously store the real-time data samples to a storage device, e.g., the training data 122 and/or the storage(s) 108, as shown in FIG. 1. The server(s) 110 and/or the security appliance(s) 106 may further group similar data samples using a fuzzy/similarity hashing algorithm, such as DeepHash, and place those similar data samples in a same storage device. In some examples, the storage device may include local storage devices, remote storage devices, cloud storage devices, object storage buckets (e.g., the plurality of buckets 204 as shown in FIG. 1), etc. While the patterns of the malware activities may vary, the majority of the detected events may exhibit common patterns. Thus, some storages may hold a large size of data samples in common patterns while some storages may hold a small size of data samples that are rare and/or newly observed.

At operation 704, the process may include performing a sequence of samplings on the plurality of storages. The sequence of samplings may include a threshold sampling described in operation 706, a top-n most recent sampling described in operation 708, and a top-n least confident sampling described in operation 710.

At operation 706, the process may include determining whether a number of data samples in a storage is greater than a threshold. As discussed herein, utilizing a full set of data samples to train the malware detection model may be inefficient and place a huge computational burden on the servers. In addition, training the malware detection model using the large sized buckets of data samples with common patterns may cause the model not to perform well on newly detected patterns and/or rarely seen patterns. The server(s) 110 and/or the security appliance(s) 106 may select a number of buckets that have a number of data samples equal to or less than the threshold to ensure the potentially critical patterns are included for model training. The data samples in the selected number of buckets (i.e., small-sized buckets) may be used directly for model training without pruning. In implementations, the server(s) 110 and/or the security appliance(s) 106 may set a threshold on the number of samples in the storage based on an empirical cumulative distribution function (ECDF). In some examples, the threshold may be set to choose 99.75% of the buckets, where each of the 99.75% of the buckets holds 270 or fewer data samples. As such, small-sized buckets may be preserved to ensure diversity and uniqueness of the model training data.

Therefore, if the number of data samples is equal to or less than the threshold, at operation 720, the process may include sending the data samples in the storage to a database for model training. The server(s) 110 and/or the security appliance(s) 106 may generate a first set of data samples, e.g., a subset of training data from the original training data (e.g., training data 122 shown in FIG. 1). The first set of data samples may be further used to construct the model training data (e.g., the model training data 212 of FIG. 2).

If the number of data samples in a storage is greater than the threshold, at operation 708, the process may include determining whether a data sample in the storage is top-n most recent data samples. As the events on the network are constantly monitored, newly detected events may exhibit uncommon behavior or pattern. The server(s) 110 and/or the security appliance(s) 106 may select the recent data samples to be included for model training. In some examples, the server(s) 110 and/or the security appliance(s) 106 may select top-n most recent data samples from each bucket, where n can be set as any number such as 5,10, 15, etc.

In implementations, the server(s) 110 and/or the security appliance(s) 106 may check every data sample in the large-sized storage. If the data sample is a top-n most recent sample, the process may continue at operation 720 to save the data sample for model training. If the data sample is not a top-n most recent sample, at operation 710, the process may include determining whether the data sample is a top-n least confident sample.

As discussed herein, each data sample includes a detection result outputted by the malware detection model. For some events, the malware detection model may output low confidence levels that these events are potentially malicious. The server(s) 110 and/or the security appliance(s) 106 may select the data samples with low confidence levels from each storage and include these data samples for model training. In some examples, the server(s) 110 and/or the security appliance(s) 106 may select top-n least confident samples from the large-sized storage, where n can be set as any number such as 5, 10, 15, etc. In some examples, the server(s) 110 and/or the security appliance(s) 106 may select a number of top recent samples and the same number of top least confident samples from large-sized storage. In some other examples, the server(s) 110 and/or the security appliance(s) 106 may select the first number of top recent samples and a second number of top least confident samples from large-sized storage, where the first number of top recent samples is different from the second number of least confident samples.

If the data sample is a top-n least confident sample, the process may continue at operation 720 to save the data sample for model training. If the data sample is not a top-n least confident sample, at operation 712, the process may include determining whether all storages are processed for the top-n most recent sampling and the top-n least confident sampling. If there are still some storages unprocessed, the process may return to operation 704.

If all storages are processed using the top-n most recent sampling and the top-n least confident sampling, at operation 714, the process may include performing a Monte Carlo sampling method to generate additional data samples for model training. As discussed herein, the threshold sampling performed at operation 706 sets aside the small-sized buckets to be used for model training directly. The rest storages, after the top-n most recent sampling and the top-n least confident sampling, may be further sampled using Monte Carlo sampling methods to generate additional data samples for model training. In some examples, the computer device may perform Monte Carlo sampling strategy enhanced with a power transformation across the rest storages, which would allow the computer device to probabilistically weight the selection, ensuring that the model training data is not just representative of large corpus, but also balanced in terms of data diversity.

At operation 716, the process may include sending the additional data samples to the database for model training.

At operation 718, the process may include archiving the unselected data samples. As discussed herein, the archived data samples and/or storages may be periodically revisited, reevaluated, and/or included in model validation.

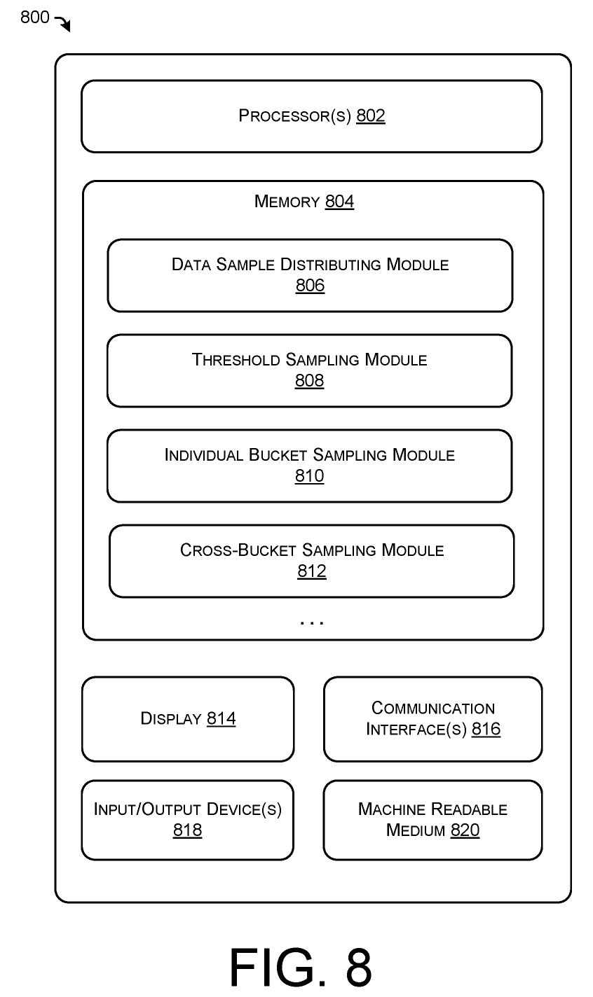

FIG. 8 illustrates an example computer device that implements techniques for enhanced data pruning for malware detection model, according to an example of the present disclosure. The example computer device 800 may be performed by the server(s) 110 and/or the security appliance(s) 106, as shown in FIG. 1.

As illustrated in FIG. 8, the computer device 800 may comprise processor(s) 802, a memory 804 storing a data sample distributing module 806, a threshold sampling module 808, an individual bucket sampling module 810, a cross bucket sampling module 812, a display 814, communication interface(s) 816, input/output device(s) 818, and/or a machine readable medium 820.

In various examples, the processor(s) 802 can be a central processing unit (CPU), a graphics processing unit (GPU), or both CPU and GPU, or any other type of processing unit. Each of the one or more processor(s) 802 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 802 may also be responsible for executing all computer applications stored in memory 804, which can be associated with common types of volatile (RAM) and/or nonvolatile (ROM) memory.

In various examples, the memory 804 can include system memory, which may be volatile (such as RAM), non-volatile (such as ROM, flash memory, etc.) or some combination of the two. The memory 804 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store desired information and which can be accessed by the computer device 800. Any such non-transitory computer-readable media may be part of the computer device 800.

The data sample distributing module 806 may be configured to distribute the data samples according to their similarities. The data sample distributing module 806 groups similar data samples into a same storage or bucket using a fuzzy hashing algorithm such as DeepHash. After the data samples are saved into various buckets, the threshold sampling module 808 may be configured to select one or more buckets of data, where each bucket contains the number of data samples no greater than a pre-set threshold. The threshold sampling module 808 may focus on smaller sized buckets of data to include diverse and less-frequently observed patterns. The individual bucket sampling module 810 may be configured to perform one or more sampling operations on each bucket of data. In some examples, the individual bucket sampling module 810 may sequentially perform a top-n most recent sampling and a top-n least confident sampling on each bucket of data. The top-n most recent sampling may capture the newest data samples that have not been used to train the malware detection model yet. The top-n least confident sampling may re-include the challenging samples in the model training to improve the performance of the malware detection model. The cross-bucket sampling module 812 may be configured to apply a power transformation to construct weights for the data buckets, thereby ensuring appropriate weighting of buckets of varying sizes. Subsequently, Monte Carlo sampling is performed across all data buckets, ensuring proportional representation in the model training data. This method achieves a balanced distribution, even when the data distribution exhibits characteristics exceeding those of an exponential distribution. In some examples, the threshold sampling module 808, the individual bucket sampling module 810, and the cross-bucket sampling module 812, when performing sequential sampling, may also process the training data saved in a pool to remove any duplicate samples that are already in the pool.

The communication interface(s) 816 can include transceivers, modems, interfaces, antennas, and/or other components that perform or assist in communicating with other computer devices, servers, storages associated with various computer platforms including but are not limited to, application platform(s) 114, virtual machine(s) 112, server(s) 110, security appliance(s) 106, storage(s) 108, etc.

Display 814 can be a liquid crystal display or any other type of display commonly used in the computer device 800. For example, display 814 may be a touch-sensitive display screen and can then also act as an input device or keypad, such as for providing a soft-key keyboard, navigation buttons, or any other type of input. Input/output device(s) 818 can include any sort of output devices known in the art, such as display 814, speakers, a vibrating mechanism, and/or a tactile feedback mechanism. Input/output device(s) 818 can also include ports for one or more peripheral devices, such as headphones, peripheral speakers, and/or a peripheral display. Input/output device(s) 818 can include any sort of input devices known in the art. For example, input/output device(s) 818 can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

The machine readable medium 820 can store one or more sets of instructions, such as software or firmware, which embodies any one or more of the methodologies or functions described herein. The instructions can also reside, completely or at least partially, within the memory 804, processor(s) 802, and/or communication interface(s) 816 during execution thereof by the computer device 800. The memory 804 and the processor(s) 802 also can constitute machine readable media 820.

The various techniques described herein may be implemented in the context of computer-executable instructions or software, such as program modules, which are stored in computer-readable storage and executed by the processor(s) of one or more computer devices such as those illustrated in the figures. Generally, program modules include routines, programs, objects, components, data structures, etc., and define operating logic for performing particular tasks or implement particular abstract data types.

Other architectures may be used to implement the described functionality and are intended to be within the scope of this disclosure. Furthermore, although specific distributions of responsibilities are defined above for purposes of discussion, the various functions and responsibilities might be distributed and divided in unusual ways, depending on circumstances.

Similarly, software may be stored and distributed in numerous ways and using different means, and the particular software storage and execution configurations described above may be varied in many different ways. Thus, software implementing the techniques described above may be distributed on various types of computer-readable media, are not limited to the forms of memory that are specifically described.

### Conclusion

Although the subject matter has been described in language specific to structural features and/or methodological acts, it is to be understood that the subject matter is not necessarily limited to the specific features or acts described above. Rather, the specific features and acts described above are disclosed as example examples.

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at various times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A computer-implemented method comprising:
receiving, by a processor, data samples associated with events detected in a computer network;
distributing, by the processor, the data samples into a plurality of storages;
obtaining, by the processor, and based on one or more storages of the plurality of storages, a first set of data samples, wherein the one or more storages satisfy a first criteria;
obtaining, by the processor, and based on a first sampling on individual storage of rest storages in the plurality of storages, a second set of data samples;
obtaining, by the processor, and based on a second sampling across the rest storages in the plurality of storages, a third set of data samples;
generating, by the processor, and based on the first set of data samples, the second set of data samples, and the third set of data samples, a training dataset; and
providing, by the processor, and to a computer device, the training dataset to train a malware detection model.

2. The computer-implemented method of claim 1, wherein distributing, by the processor, the data samples into a plurality of storages further comprises:
storing, by the processor, and based on a locality sensitive hashing (LSH) algorithm, similar data samples to a same storage.

3. The computer-implemented method of claim 1, wherein
the first criteria correspond to a threshold number of the data samples in a storage, and
a number of data samples in each of the one or more storages is equal to or less than the threshold number,
wherein the threshold number is determined based on an empirical cumulative distribution function (ECDF).

4. The computer-implemented method of claim 1, wherein obtaining, by the processor, and based on a first sampling on individual storage of rest storages in the plurality of storages, a second set of data samples further comprises:
selecting, by the processor, and from each individual storage, a first number of most recent data samples;
selecting, by the processor, and from each individual storage, a second number of least confident data samples; and
generating, by the processor, and based on the first number of most recent data samples and the second number of least confident data samples, the second set of data samples.

5. The computer-implemented method of claim 4, further comprising:
prior to selecting, by the processor, and from each individual storage, the second number of least confident data samples,
removing, by the processor, the first number of most recent data samples from each individual storage.

6. The computer-implemented method of claim 5, further comprising:
prior to obtaining, by the processor, and based on the second sampling across the rest storages in the plurality of storages, the third set of data samples,
removing, by the processor, the second number of most least confident data samples from each individual storage.

7. The computer-implemented method of claim 1, wherein the second sampling is performed using a Monte Carlo sampling algorithm with a power transformation based on individual sizes of the plurality of storages.

8. The computer-implemented method of claim 1, further comprising:
for each of the events detected in the computer network,
inputting, by the processor, information associated with the event to the malware detection model;
executing, by the processor, the malware detection model to generate a detection result, the detection result indicating a confidence level that the event is malicious; and
generating, by the processor, the data sample corresponding to the event, the data sample including the information and the confidence level.

9. A computer system comprising:
a processor,
a network interface, and
a memory storing instructions executed by the processor to perform operations including:
receiving, by a processor, data samples associated with events detected in a computer network;
distributing, by the processor, the data samples into a plurality of storages;
obtaining, by the processor, and based on one or more storages of the plurality of storages, a first set of data samples, wherein the one or more storages satisfy a first criteria;
obtaining, by the processor, and based on a first sampling on individual storage of rest storages in the plurality of storages, a second set of data samples;
obtaining, by the processor, and based on a second sampling across the rest storages in the plurality of storages, a third set of data samples;
generating, by the processor, and based on the first set of data samples, the second set of data samples, and the third set of data samples, a training dataset; and
providing, by the processor, and to a computer device, the training dataset to train a malware detection model.

10. The computer system of claim 9, wherein distributing, by the processor, the data samples into a plurality of storages further comprises:
storing, by the processor, and based on a locality sensitive hashing (LSH) algorithm, similar data samples to a same storage.

11. The computer system of claim 9, wherein
the first criteria correspond to a threshold number of the data samples in a storage, and
a number of data samples in each of the one or more storages is equal to or less than the threshold number,
wherein the threshold number is determined based on an empirical cumulative distribution function (ECDF).

12. The computer system of claim 9, wherein obtaining, by the processor, and based on a first sampling on individual storage of rest storages in the plurality of storages, a second set of data samples further comprises:
selecting, by the processor, and from each individual storage, a first number of most recent data samples;
selecting, by the processor, and from each individual storage, a second number of least confident data samples; and
generating, by the processor, and based on the first number of most recent data samples and the second number of least confident data samples, the second set of data samples.

13. The computer system of claim 12, wherein the instructions are executed by the processor to perform operations further comprising:
prior to selecting, by the processor, and from each individual storage, the second number of least confident data samples,
removing, by the processor, the first number of most recent data samples from each individual storage.

14. The computer system of claim 13, wherein the instructions are executed by the processor to perform operations further comprising:
prior to obtaining, by the processor, and based on the second sampling across the rest storages in the plurality of storages, the third set of data samples,
removing, by the processor, the second number of most least confident data samples from each individual storage.

15. The computer system of claim 9, wherein the second sampling is performed using a Monte Carlo sampling algorithm with a power transformation based on individual sizes of the plurality of storages.

16. The computer system of claim 9, wherein the instructions are executed by the processor to perform operations further comprising:
for each of the events detected in the computer network,
inputting, by the processor, information associated with the event to the malware detection model;
executing, by the processor, the malware detection model to generate a detection result, the detection result indicating a confidence level that the event is malicious; and
generating, by the processor, the data sample corresponding to the event, the data sample including the information and the confidence level.

17. A computer-readable storage medium storing computer-readable instructions, that when executed by a processor, cause the processor to perform operations including:
receiving, by a processor, data samples associated with events detected in a computer network;
distributing, by the processor, the data samples into a plurality of storages;
obtaining, by the processor, and based on one or more storages of the plurality of storages, a first set of data samples, wherein the one or more storages satisfy a first criteria;
obtaining, by the processor, and based on a first sampling on individual storage of rest storages in the plurality of storages, a second set of data samples;
obtaining, by the processor, and based on a second sampling across the rest storages in the plurality of storages, a third set of data samples;
generating, by the processor, and based on the first set of data samples, the second set of data samples, and the third set of data samples, a training dataset; and
providing, by the processor, and to a computer device, the training dataset to train a malware detection model.

18. The computer-readable storage medium of claim 17, wherein
the first criteria correspond to a threshold number of the data samples in a storage, and
a number of data samples in each of the one or more storages is equal to or less than the threshold number,
wherein the threshold number is determined based on an empirical cumulative distribution function (ECDF).

19. The computer-readable storage medium of claim 17, wherein obtaining, by the processor, and based on a first sampling on individual storage of rest storages in the plurality of storages, a second set of data samples further comprises:
selecting, by the processor, and from each individual storage, a first number of most recent data samples;
selecting, by the processor, and from each individual storage, a second number of least confident data samples; and
generating, by the processor, and based on the first number of most recent data samples and the second number of least confident data samples, the second set of data samples.

20. The computer-readable storage medium of claim 17, wherein the second sampling is performed using a Monte Carlo sampling algorithm with a power transformation based on individual sizes of the plurality of storages.
